(19) United States
(12) Patent Application Publication
(10) Pub. No.: US 2017/0212785 A1
(43) Pub. Date: Jul. 27, 2017

(54) METHOD AND DEVICE FOR MONITORING AND CONTROLLING QUASI-PARALLEL EXECUTION THREADS IN AN EVENT-ORIENTED OPERATING SYSTEM

(71) Applicant: Robert Bosch GmbH, Stuttgart (DE)

(72) Inventors: Gunnar Piel, Hemmingen (DE); Arnaud Riess, Korntal-Muenchingen (DE); Florian Kraemer, Pfedelbach (DE); Steffen Klinger, Backnang (DE)

(21) Appl. No.: 15/403,621

(22) Filed: Jan. 11, 2017

(30) Foreign Application Priority Data
Jan. 21, 2016 (DE) 102016200777.7

(51) Int. Cl. G06F 9/48; G06F 9/52

(52) U.S. Cl. CPC G06F 9/4881; G06F 9/52

(57) ABSTRACT

A method for monitoring quasi-parallel execution threads in an event-oriented operating system, in which an administration process, privileged by the operating system, monitors operating events triggered by the execution threads with the aid of a kernel of the operating system, and with the aid of the operating events, the administration process constantly monitors a run-time behavior of the execution threads specified by the configuration.

### CROSS REFERENCE

The present application claims the benefit under 35 U.S.C. §119 of German Patent Application No. DE 102016200777.7 filed on Jan. 21, 2016, which is expressly incorporated herein by reference in its entirety.

### FIELD

The present invention relates to a method for monitoring and controlling quasi-parallel execution threads in an event-oriented operating system. Furthermore, the present invention relates to a corresponding device, a corresponding computer program and to a corresponding storage medium.

### BACKGROUND INFORMATION

The portable operating system interface ISO/IEC/IEEE 9945 standardized in the international standards encompasses a number of specific application environment profiles (AEPs) for open system. Among them are, in particular, the environment profiles defined according to IEEE 1003.13.2003 for portable, real-time capable and embedded applications.

German Patent Application No. DE 10 2014 103139 A1 relates to a method for porting old control software that is developed for a control device having a single processor core, to a vehicle control device having at least two processor cores. Old control software includes tasks that have one or more executive routine(s) as well as an execution or preemptive hierarchy for the tasks in each case. Priority restrictions for writing and reading accesses to shared persistent memory variables are ascertained and weak priority restrictions are identified according to predefined classification rules. An execution plan for the execution of the old control software on the two or more processor cores is generated, i.e., by parallelization of executive routines that have weak priority restrictions. For each weak priority restriction, the associated persistent memory variable is stored in a separately administered database that permits a read and write access without waiting time.

### SUMMARY

The present invention provides a method for monitoring and controlling quasi-parallel execution threads in an event-oriented operating system, a corresponding device, a corresponding computer program and a corresponding memory medium according to the independent claims.

According to the present invention, in software systems that are subject to function and information security demands, a mutual freedom from interference (FFI) of the various software components may be of special importance.

This freedom from interference is to be ensured in two regards. For one, a space FFI is to be represented. In POSIX-compliant operating systems, this is mainly realized via processes or resource partitions. The operating system prevents access to the memory area of a process or a partition by another process or another partition. Identical criticality from the aspect of information technology is presupposed within a process or a partition, i.e., a probability and expected effect of possible interferences of the operating safety that is to be assessed uniformly.

For another, temporal FFI is to be made possible. That means that in the most critical case, a starting instant, a latest end instant as well as a net run-time budget must be guaranteed to each thread of different processes or partitions. It has shown to be essential that both the monitoring as well as the controlling of these characteristics are ensured by a reliable software instance.

This finely granular temporal FFI is nearly impossible to represent in a conventional POSIX-compliant operating system with provided scheduling algorithms.

In contrast, one advantage of the approach according to the present invention consists of the possibility of assuring temporal FFI at the thread level, in particular in POSIX-compliant operating systems. This mutual freedom from interference even applies to threads that are allocated to different processes or partitions. In this way processes having different criticality with regard to information and function security are able to be operated deterministically in the same run-time environment. In addition, a functional interplay of the threads of processes that have different criticality is also able to be achieved, even at a guaranteed execution time, starting instant and deadline for each individual thread.

In accordance with one specific embodiment of the present invention, an administration process is provided, the tasks of which include monitoring and controlling of the threads. This is a process that was developed in accordance with the highest demands on its function and information security and which was therefore classified as trustworthy. The administration process was designed on the basic assumption that not all threads to be monitored are trustworthy. It includes all required information about the temporal behavior of the threads of the kernel of the operating system. This kernel satisfies the same demands with regard to the function and information security as said administration process itself. The latter constantly compares the actual temporal behavior of the threads, of which it is notified via trustworthy kernel mechanisms, to a trustworthy configuration. If the administration process notices a deviation from the expected temporal behavior, then it outputs corresponding commands to the kernel in order to neutralize the faulty behavior or to initiate replacement reactions.

Advantageous further developments and improvements of the present invention are possible as a result of the measures described herein. The temporal behavior of the threads to be monitored, in particular, is able to be controlled in two ways. The two possibilities described in the following text are also combinable with each other. For example, it may be provided that the threads adapt their temporal behavior among each other. In this instance, the administration process monitors only the correct temporal sequence. This method of action has the advantage that the application processes need not be instrumentalized or provided with additional synchronization mechanisms. One development of the present invention that corresponds to the described approach is referred to as “passive specific embodiment” in the following text.

According to another aspect, it may be the case that the administration process assumes the temporal control in that the threads synchronize with the administration process via established synchronization mechanisms, such as a synchronous message exchange (message passing), or semaphores. For one, it controls the synchronization and for another, it monitors the correct sequence. This offers the possibility of decoupling and resultant FFI of the threads from processes of different criticality, but requires the incorporation of selective synchronization mechanisms into the application processes. A corresponding variant is referred to as “active specific embodiment” is described herein.

### BRIEF DESCRIPTION OF THE DRAWINGS

Exemplary embodiments of the present invention are shown in the figures and described in greater detail below.

FIG. 1 shows the flow diagram of a method for monitoring execution threads.

FIG. 2 shows the block diagram of an active specific embodiment of the method of the present invention.

FIG. 3 shows the block diagram of a passive specific embodiment.

### DETAILED DESCRIPTION OF EXAMPLE EMBODIMENTS

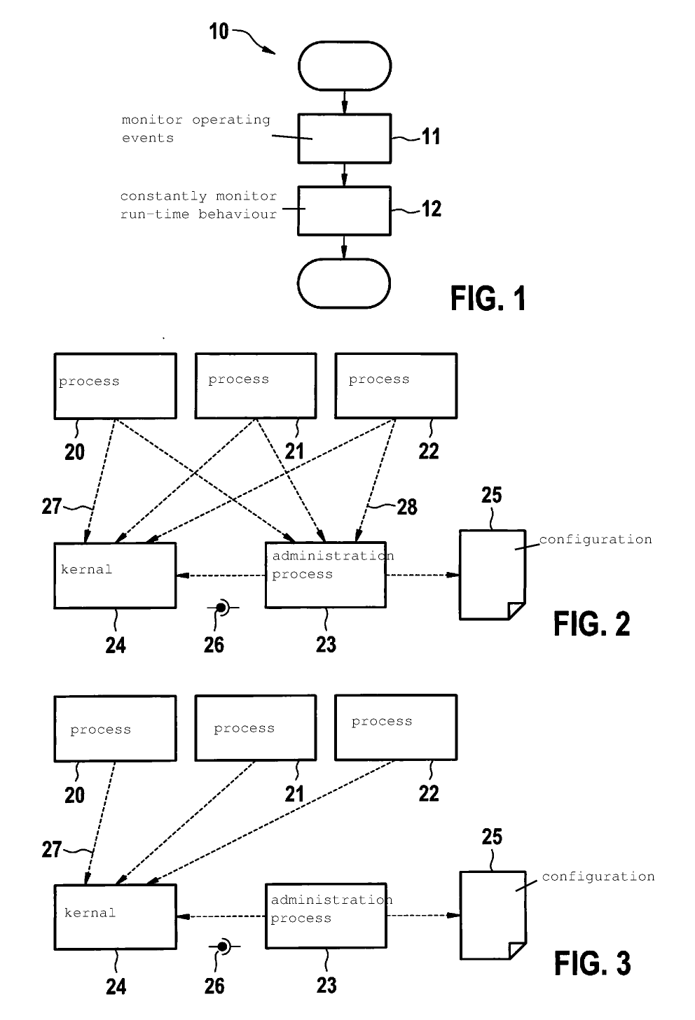

FIG. 1 illustrates the basic sequence of a method (10) according to a generic specific embodiment of the present invention, which is used for monitoring quasi-parallel execution threads in a multi-tasking operating system. Any at least seemingly concurrent process of information processing running on the basis of algorithms under the supervision of the operating system is understood as constituting quasi-parallel execution thread. Included are therefore not only processes in the stricter sense of the word, to which a processor or a processor core is allocated exclusively within the time slot periodically assigned to them by the scheduler. Instead, the term also includes what is known as light-weight processes (20, 21, 22) or activity carriers (threads), which in an expansion of the classic process model, share operating means and context of a process (20, 21, 22) with other activity carriers and merely have their own stack memory (stack).

The method of functioning of the method (10) becomes clear from an overall view of FIGS. 2 and 3 in the following way: Kernel (24) of the operating system, which is POSIX-compliant in the case at hand, provides a programming interface (application programming interface, API), which as administration interface (26) is accessible exclusively to an administration process (23) to which explicit access has been granted. The access right may be safeguarded via different mechanisms. Possible, in particular, are a mandatory access control (MAC), a user-definable access control (discretionary access control, DAC) or a role-based access control (RBAC). In contrast, processes (20, 21, 22) not given such privileges are restricted to system calls (27) provided for the applications. It is understood that the method (10) is able to be used in a corresponding manner for only partially POSIX-compliant operating systems without departing from the scope of the present invention.

Administration interface (26) preferably offers at least the following methods:
Querying the status of a processor (20, 21, 22); for instance, conceivable are the possible statuses “in execution”, “blocked” or “non-existent”,
Querying the gross run-time of a process (20, 21, 22) since a configurable status change, in other words, the total length of the time interval required for its execution,
Querying the net run-time of a process (20, 21, 22) since a configurable status change, i.e. said gross run-time minus the duration of possible interruptions by other processes (20, 21, 22),
Querying a list of instantiated processes (20, 21, 22),
Querying a list of instantiated threads of a process (20, 21, 22),
Querying the priorities of instantiated threads,
Notification of an operating event (event notification), which marks the status change of a specific thread,
Notification of the instantiation or termination of a process (20, 21, 22),
Notification of the instantiation or termination of the thread of a specific process (20, 21, 22),
Notification of the change in the priority of a thread,
Notification upon reaching a certain gross run-time of a thread since a specific status change, based on the granularity of the operating system time (system tick) administered by the kernel (24),
Notification upon reaching of a specific net run-time of a thread since a specific status change based on the granularity of the operating-system time administered by the kernel (24),
Notification upon reaching of the maximum off-time of a specific operating means based on the granularity of the operating-system time administered by the kernel (24), the blocking possibly being implemented with the aid of a semaphore, for example, in particular a mutual exclusion (mutex),
Ending a process (20, 21, 22),
Ending a thread,
Preemption, i.e. the temporary interruption, of one more thread( )s),
Setting a thread priority or thread priority span, and
Setting the priority or priority span of all threads of a particular process (20, 21, 22).

The administration process (23) includes a configuration (25) which contains the correct attributes of the run-time behavior of the threads and processes (20, 21, 22) to be monitored and controlled. This configuration (25) may be variable at the run-time, either statically or dynamically.

Furthermore, the administration process (23) includes its own sufficiently precise timing circuit, e.g., a highly precise electronic control component, with the aid of which it checks the actual time behavior of the execution threads (20, 21, 22) in comparison to the configuration (25).

On the basis of the currently valid configuration (25), administration process (23) registers itself via administration interface (26) for the notification of operating events that characterize the run-time behavior of execution threads (20, 21, 22). Furthermore, the administration process is able to query current values and statuses of execution threads (20, 21, 22) at all times via administration interface (26).

The administration process (23) may instantiate processes (20, 21, 22) on its own or leave it to another software instance, for example to another process or startup script.

According to the passive specific embodiment represented in FIG. 3, the administration process (23) constantly monitors all values and sequences indicated in the configuration (25).

In the active specific embodiment according to FIG. 2, the administration process (23) additionally assumes the temporal control of threads via synchronization mechanisms between the threads and the administration process (23) that are made available by the kernel (24) of the operating system.

If the administration process (23) detects a deviation of the actual temporal behavior from its configuration (25), then it neutralizes the deviation, for instance by terminating a process (20, 21, 22), by preempting a thread or by lowering the thread priority, or it initiates replacement reactions of the kernel (24) via administration interface (26), such as the restart of a process (20, 21, 22).

What is claimed is:

1. A method for monitoring quasi-parallel execution threads in an event-oriented operating system, comprising:
monitoring, by an administration process privileged by the operating system, operating events, triggered by the execution threads, with the aid of a kernel of the operating system; and
constantly monitoring on the basis of the operating events, by the administration process, a run-time behavior of the execution threads specified by a configuration.

2. The method as recited in claim 1, wherein:
monitoring of the operating events takes place via an administration interface provided to the administration process by the kernel,
the administration process is notified as needed via the administration interface in response to a query, about an operating status of the execution threads, and
the monitoring of the run-time behavior takes place on the basis of the operating status.

3. The method as recited in claim 2, wherein:
the administration process outputs to the kernel via the administration interface an administration command if the run-time behavior deviates from the configuration, and
in response to the administration command, the kernel one of neutralizes the deviating run-time behavior or initiates a replacement reaction, the replacement reaction being a new start of one of the application threads.

4. The method as recited in claim 3, wherein one of:
i) the kernel including a preemptive scheduler, and wherein at least one of the neutralization includes a termination of one of the execution threads, and the neutralization includes a temporary interruption of one of the execution threads, or ii) the kernel is a priority scheduler, and the neutralization includes a downgrading of one of the execution threads to a lower priority level.

5. The method as recited in claim 1, wherein:
the execution threads initiate with the aid of the kernel a synchronization with the administration process if needed, and
the administration process temporally controls the execution threads by the synchronization.

6. The method as recited in claim 5, wherein at least one of the following:
the synchronization includes a synchronous message exchange between the execution threads on the one hand, and
the administration process on the other, or the synchronization takes place by way of a synchronization mechanism, the synchronization mechanism being a semaphore.

7. The method as recited in claim 1, wherein at least one of the following:
the execution thread is an application process, or
the execution thread is a thread.

8. A non-transitory machine-readable storage medium on which is stored a computer program for monitoring quasi-parallel execution threads in an event-oriented operating system, the computer program, when executed by a processor, causing the processor to perform:
monitoring, by an administration process privileged by the operating system, operating events, triggered by the execution threads, with the aid of a kernel of the operating system; and
constantly monitoring on the basis of the operating events, by the administration process, a run-time behavior of the execution threads specified by a configuration.

9. A device for monitoring quasi-parallel execution threads in an event-oriented operating system, the device designed to:
cause monitoring, by an administration process privileged by the operating system, operating events, triggered by the execution threads, with the aid of a kernel of the operating system; and
cause constant monitoring on the basis of the operating events, by the administration process, a run-time behavior of the execution threads specified by a configuration.
